(19) United States
(12) Patent Application Publication
(10) Pub. No.: US 2017/0114759 A1
(43) Pub. Date: Apr. 27, 2017

(54) INTAKE MANIFOLD TURNING VANES

(71) Applicant: Ford Global Technologies, LLC, Dearborn, MI (US)

(72) Inventor: Gary Nola, Detroit, MI (US)

(21) Appl. No.: 14/920,626

(22) Filed: Oct. 22, 2015

(51) Int. Cl. F02M 35/104; F02M 35/10

(52) U.S. Cl. CPC F02M 35/104; F02M 35/10078

(57) ABSTRACT

Methods and systems are provided for modifying intake flow for internal combustion engines. The turning vanes have inlet ends positioned substantially coplanar and spaced from respective runner openings and have surfaces that converge from the inlet ends toward outlet ends to be increasingly less obstructive to air moving across the plenum as measured in a direction away from the inlet end and toward the respective runner openings. The outlet ends being positioned within each respective runner opening.

### FIELD

The present description relates generally to modifying intake flow into runners of an intake manifold, and in particular turning vanes positioned partway into the openings of the runners and having turning vane inlets positioned in an intake manifold plenum.

### BACKGROUND/SUMMARY

The intake manifold of an internal combustion engine provides intake air to the engine for combustion. Typically air may enter a plenum via an air intake, and the flow may be separated multiple flows via runners extending from the plenum and corresponding to a respective number of cylinders to be mixed with a fuel and combusted. The volumetric efficiency of the engine refers at least partly to the efficiency with which the engine can move a quantity of air into a cylinder for combustion.

In some cases the primary runners of an intake manifold may be at least partially responsible for lowering the volumetric efficiency of internal combustion engines. This may be due to the flow characteristics of the flow into the runners.

Attempts have been made to modify the flow from the intake air inlet into the combustion chambers of the engine. For example U.S. Pat. No. 6,886,532 discloses a collector equipped intake system of an internal combustion engine. The collector is fixed to a cylinder-head side wall with a collector mounting bracket. The mounting bracket hermetically covers perimeters of the opening end portions of a plurality of intake ports. A plurality of intake manifold branches, which each respectively communicate with the plurality of the intake ports, protrude into the interior space of the collector.

However, the inventors herein have recognized potential issues with such systems. As one example, the protruding manifold branches of the mounting bracket provide a relatively wide obstruction to any cross flow through the interior space of the collector. Accordingly flow of air past one intake-manifold branch will tend to be obstructed from flowing toward and into another intake manifold. This may tend to disrupt flow into the combustion chamber(s) and may also reduce the volumetric efficiency of the engine. In addition the hermetically covered perimeters of intake-port opening end portions (by the collector mounting bracket) appears to prevent direct flow from the interior space of the collector into the intake ports.

In one example, the issues described above may be addressed by providing turning vanes for an intake manifold. The turning vanes may include inlet ends to be positioned in a plenum of the intake manifold such that the inlet ends may be disposed substantially coplanar in a plane. The plane may be at a spaced apart location from respective runner openings. The turning vanes may also include passages defined by respective one or more surfaces that converge from the inlet ends toward respective outlet ends. The passages may have a central axis substantially orthogonal with the plane. The one or more surfaces may be increasingly less obstructive to air moving across the plenum as measured in a direction away from the inlet end and toward the respective runner openings. The outlet ends may be positioned within each respective runner opening.

In this way, airflow into the runners may be smoother which may mitigate some unwanted flow characteristics. The turning vanes may be positioned such that they are aligned with the ideal airflow paths into the runners, since the vanes include outside surfaces that converge from the inlet ends toward respective outlet ends they may be less prone to cause flow issues with other runners. The technical effect of providing the above disclosed turning vanes is that volumetric efficiency may be substantially kept to advantageous levels.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic system diagram illustrating an example embodiment in accordance with the present disclosure.

FIG. 2 is a perspective view of an example intake manifold with a top portion thereof removed to show an interior perspective of an example turning vane positioned partway into a runner in accordance with the present disclosure.

FIG. 3 is a perspective view of a portion the intake manifold shown in FIG. 2 with portions “ghosted” to show some internal elements, in particular at an inlet side, or entry, of the plenum.

FIG. 4 is a perspective view similar to FIG. 3 looking from an opposite side of the plenum.

FIG. 5 is a perspective view of the intake manifold with portions ghosted to show three turning vanes positioned partway into three respective runners in accordance with the present disclosure.

FIG. 6 is a perspective view of a portion the intake manifold showing a single turning vane supported in place by spacers in accordance with the present disclosure.

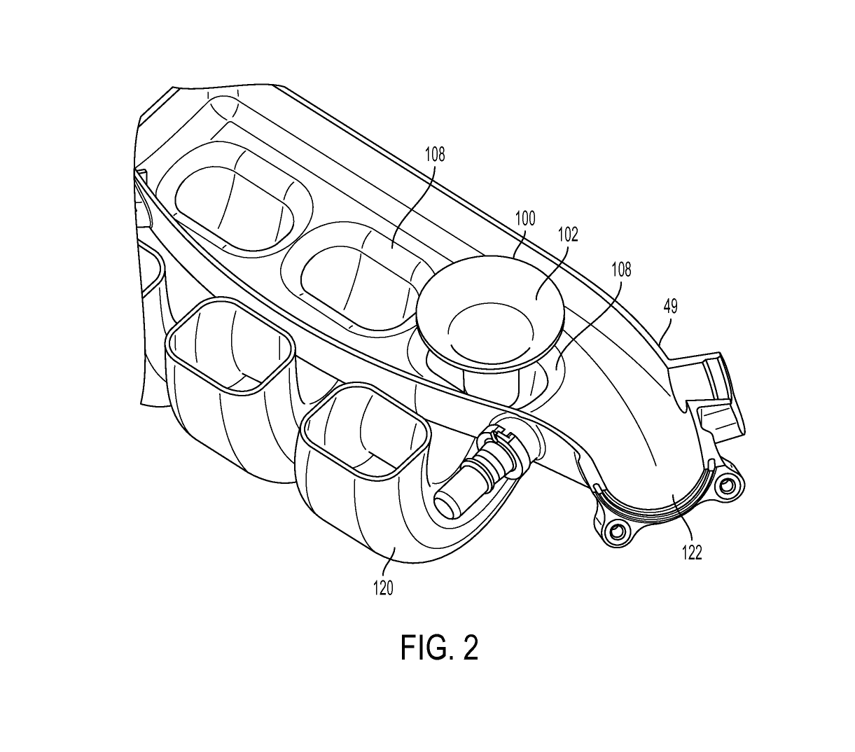

FIGS. 2-6 are shown approximately to scale.

FIG. 7 is a flow diagram illustrating an example method in accordance with the present disclosure.

FIG. 8 is a flow diagram illustrating an example variation of the method illustrated in FIG. 7.

FIG. 9 is a flow diagram illustrating another example variation of the method illustrated in FIG. 7.

### DETAILED DESCRIPTION

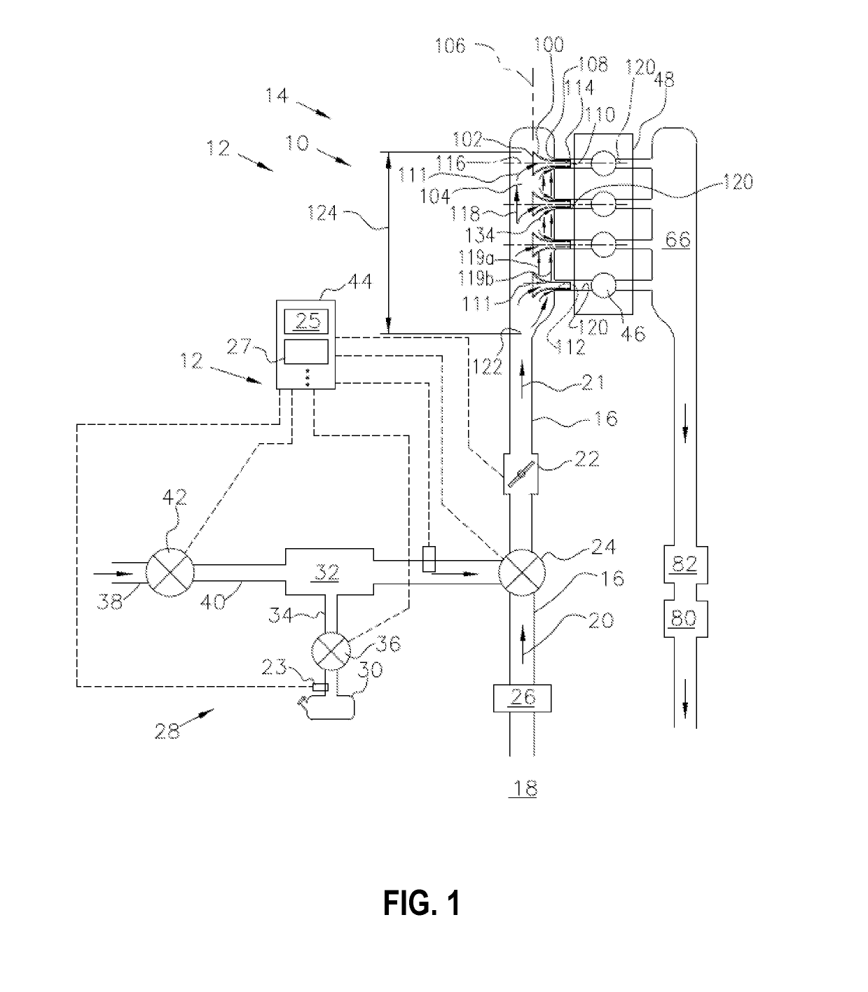

The following description relates to systems and methods for modifying intake flow into runners of an intake manifold. FIG. 1 is a schematic diagram illustrating an example engine system 10 in accordance with the current disclosure. The engine system 10 may include, or be included in, an engine 12, which may be included in, or with, a vehicle system 14. The engine system 10 may include an engine intake passage 16 for drawing in atmospheric air 18 into the engine 12 for combustion.

The air may pass from the engine intake passage 16 to a combustion chamber 46 via an intake manifold 49. The flow 20, 21 to the manifold 49 may be regulated by throttle 22 and may also be regulate-able by a valve 24. The throttle 22 may be operatively coupled with a user input device such as an accelerator pedal (not shown) and actuated in a known way to provide energy to the engine 12. The air may also pass through an air cleaner or air filter 26.

The engine system 12 may be coupled with, or include, a fuel system 28. The fuel system 28 may include a fuel tank 30, and an evaporative (EVAP) canister 32 fluidically coupled with the fuel tank 30 such that fuel vapor may migrate, or be routed, from the fuel tank 30 to the evaporative canister 32 via conduit 34 and may be absorbed by a fuel vapor absorbing material included within the evaporative canister 32. The fuel vapor absorbing material may be, or may include, activated carbon or the like, and may be, configured, for example, as a coating on the inside surface of the evaporative canister 32. Conduit 34 may optionally include a fuel tank isolation valve 36 that may be configured to open to allow fluidic communication between the fuel tank 30 and the evaporative canister 32, or closed to prevent communication therebetween. A fuel tank pressure sensor 35 may be located on the conduit 34, or in the fuel tank 30, to measure the fuel pressure in the fuel tank 30.

The engine system 10 may be configured to perform purging operations. During a purging operation a vent passage 38 may allow fresh air to be drawn into the evaporative canister 32. The vent passage 38 may include an upstream vent passage 39 and a downstream vent passage 40 gated by a vent valve 42 to allow fresh air to pass, or to prevent fresh air from passing to the evaporative canister 32. The vent valve 42 may be controlled by a controller 44. The purged vapors may pass to the purge valve 24 via purge passage, and then to the intake manifold 49. The purge valve 24 may also be controlled by the controller 44.

During normal operations that may include moving a vehicle within which the engine 12 is installed, and/or idling of the engine 12 engine exhaust 50 may include one or more emission control devices 52, which may be mounted in a close-coupled position in the exhaust 54. The one or more emission control devices 52 may include a three-way catalyst, lean NOx trap, diesel particulate filter, oxidation catalyst, etc.

The controller 44 may also include operative connections to sensors and/or actuators and the like that may perform, or take part in the performing various methods in accordance with the present disclosure. The sensors and/or actuators may include those mentioned already such as, without limitation, the vent valve 42, the purge valve 24, the fuel tank pressure sensor 35, and the like. Actuation of isolation valve 22 may be responsive to one or more signals from one or more sensors and/or one or more user, for example, driver inputs. The one or more signals and/or inputs may first be processed in accordance with predetermined logistical rules and/or software by the engine controller 24 which may result in predetermined actuation of the isolation valve 22. The engine controller 24 may also be configured to receive various signals from various other sensors throughout the engine system 12 and/or user inputs, and may be configured to actuate, or cause actuation of, various other mechanisms, such as other valves some of which may be discussed below. The controller 44 may include a number of different modules, or logistical units, and may be operatively coupled with, or included with, an engine control unit. For example the controller 44 may include a powertrain control module (PCM) 45 included as a part of the controller 44 or coupled with the controller 44. Other modules 47 may also be included as part(s) of the controller 44. The controller 44 may be responsive to selected engine conditions determined by one or more sensors, or user input(s), and the like.

After the purged fuel vapors 26 are passed, via the canister purge valve 30, to the combustion chamber(s) 46 and combusted the exhausted product may pass to an exhaust 64 via exhaust manifold 66 to the atmosphere 68. The engine exhaust 64 may include one or more emission control devices 70, which may be mounted in a close-coupled position in the exhaust 64. The one or more emission control devices 70 may include a three-way catalyst, lean NOx trap, diesel particulate filter, oxidation catalyst, etc.

The combustion chamber(s) 46 may be one or more combustion chambers 46 located in a respective number of cylinders. Four cylinders, and four combustion chamber(s) 46, are shown in FIG. 1. Other example engines in accordance with the present disclosure may have other numbers of cylinders, for example six, or eight cylinders.

FIG. 1 also includes turning vanes 100 that may be included with, and/or used in, or for, the intake manifold 49. The turning vanes 100 may include inlet ends 102 to be positioned in a plenum 104 of the intake manifold 49 and disposed substantially coplanar in a plane 106 illustrated with a phantom line in the figure. The plane 106 may be located at a spaced apart location from respective runner openings 108. The turning vanes 100 may also include passages 110 defined by respective one or more surfaces 112 that converge from the inlet ends 102 toward respective outlet ends 114. The passages 110 may have a central axis 116 that may be substantially orthogonal with the plane 106. The outlet ends 114 may be positioned within each respective runner opening 108, and may be disposed at least partway into each respective runner 120. The passages 110 may enable a turning vane flow 111 through the passage 110. At least a downstream portion of the turning vane flow 111 may be in a direction substantially collinear, and/or parallel, with the central axis 116. Air that passes though the turning vanes, i.e. the turning vane flow 111, may be directed such that the flow may be aligned with ideal airflow paths into runners 120. In this way volumetric efficiency may be increased.

In some example embodiments the one or more surfaces 112 of each passage 110 may form a cone. In some example embodiments the one or more surfaces 112 of each passage 110 may form a hyperboloid.

In some example embodiments the one or more surfaces 112 of each passage 110 may be arranged substantially in a line extending from to an entry 122 of the plenum to a distance 124, as illustrated with a dimension, from the entry 122. In some cases two or more on the turning vane 100 surfaces 112 may be similarly arranged in a line in manifold 49.

The one or more surfaces 112, i.e. the size and shape of the turning vanes 100, may be increasingly less obstructive to air moving across the plenum, i.e. a cross-plenum flow 118 (as illustrated with an arrow 118) as measured in a direction away from the inlet ends 102 and toward the respective runner openings 108. For example, the flow as illustrated with arrow 119a may be more obstructed than the flow at arrow 119b. This may be because of the wider cross section of the turning vanes distal from the runner openings 108 versus the thinner cross section proximate to the runner openings 108. In this way the turning vanes 100, or runners, relatively upstream in the plenum may not cause flow issues with the downstream turning vanes 100.

The one or more of the turning vanes 100 may be sized and shaped and positioned within the respective runners to allow at least some charge air, referred to herein as direct into runner flow 134 to enter the respective runner 120 without passing through the respective turning vanes 100.

The turning vane flow 111 may speed up and/or may be compressed due to the decreasing inside cross section of the inner surfaces 112 of the turning vanes 100 as the flow moves longitudinally there-through. The increased flow velocity at the outlet ends 114 may reduce pressure inside the runners 120 in the area of the runner openings. In this way, flow into the runner openings 108 direct into the runner flow 134 may be increased.

The combined flows downstream from the outlet ends 114 of the turning vanes 100, i.e. the turning vane flow 11 and the direct into the runner flow 134 may impart a swirl, and/or other flow movements. In this way, improved air/fuel mixing in the combustion chamber 46 may be achieved.

In this way, the aggregate flow 118 through the plenum, which may be substantially equal to the flow 117 through intake passage, may be redirected into the multiple flows as described, as such, due to all or a portion of the multiple flows, the volumetric efficiency of the engine may be increased.

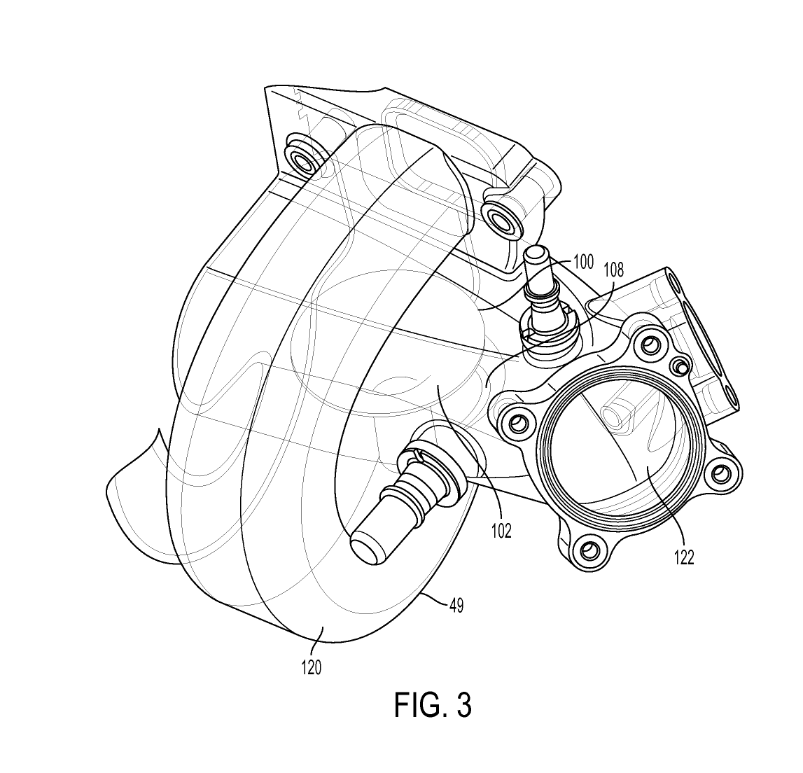

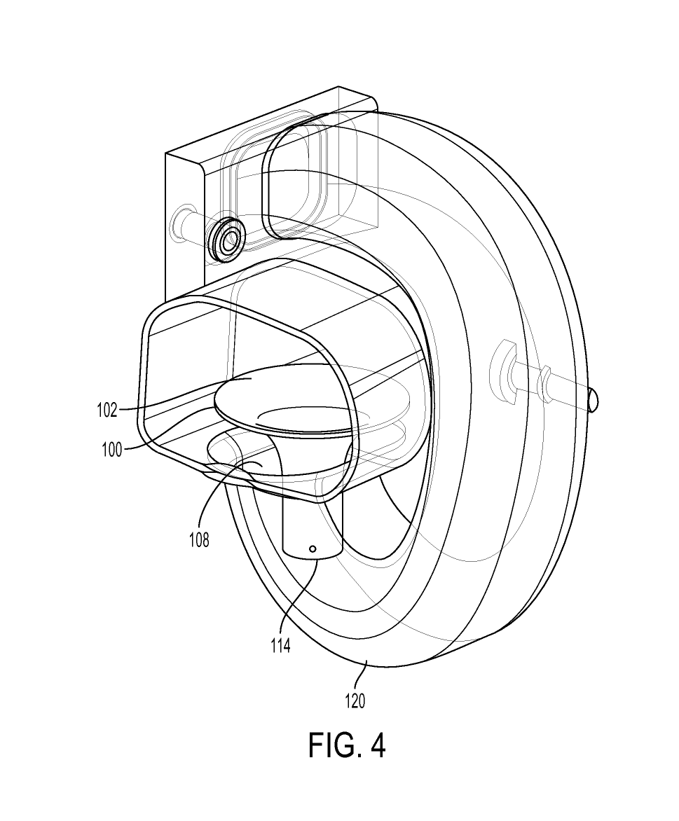

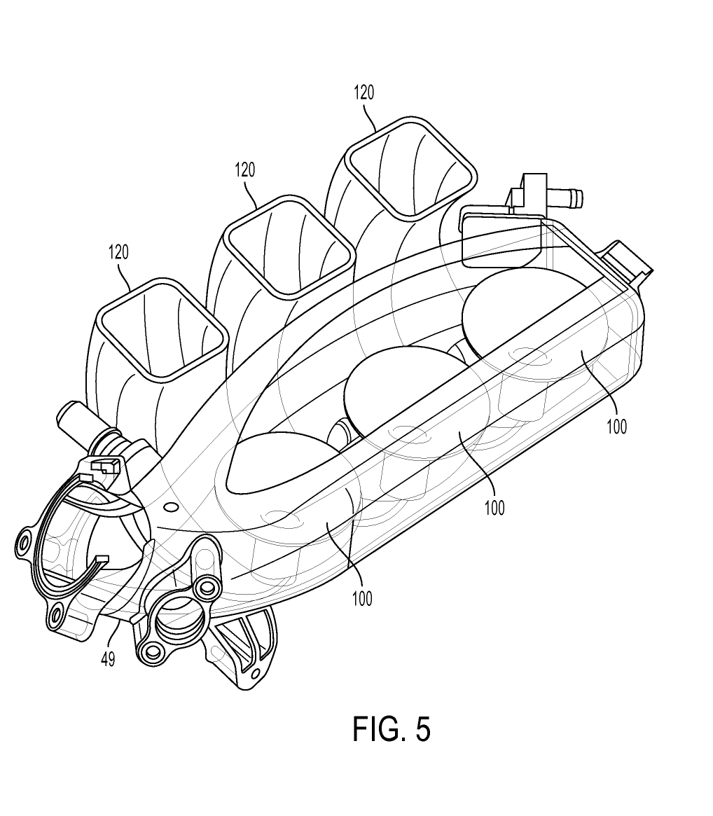

FIGS. 2-6 are various perspective views of example turning vanes 100 in place within an example intake manifold 49. FIG. 2 illustrates an intake manifold 49 with a top portion thereof removed to show an interior perspective of an inside of the manifold with one turning vane 100 in place in accordance with various embodiments. FIG. 3 shows the intake manifold 49 with the turning vane 100 at an inlet side, or entry side, of the plenum. FIG. 4 shows an example turning vane 100 in the plenum 104 at a side spaced from and/or at an opposite end 126 of the plenum, i.e. an end opposite the entry 122. FIG. 5 shows three turning vanes positioned partway into three respective runners 120.

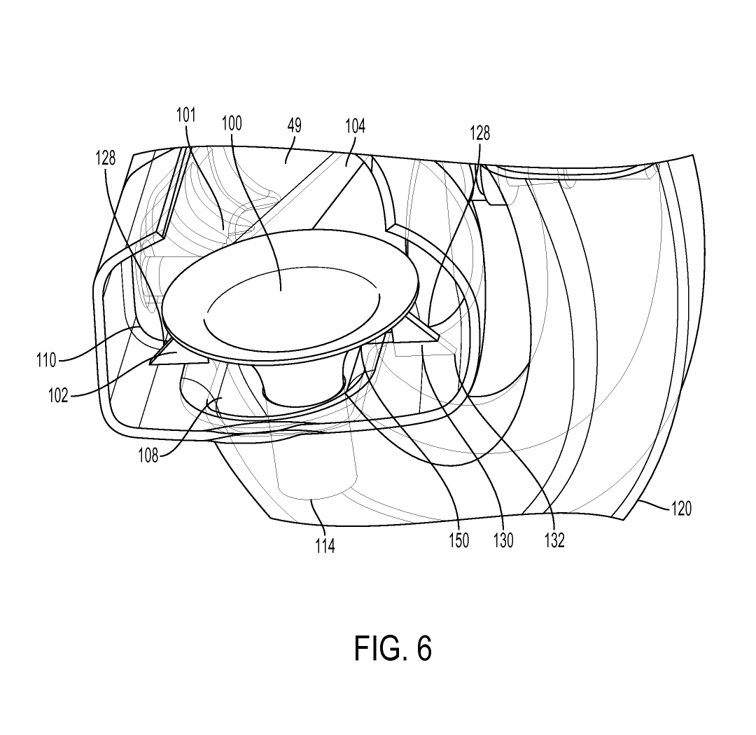

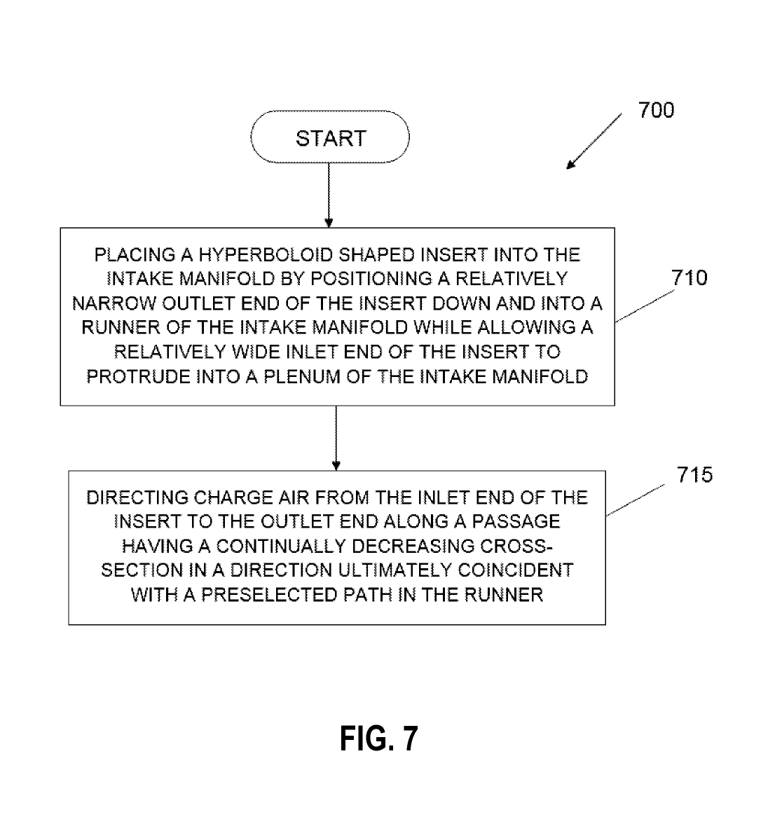

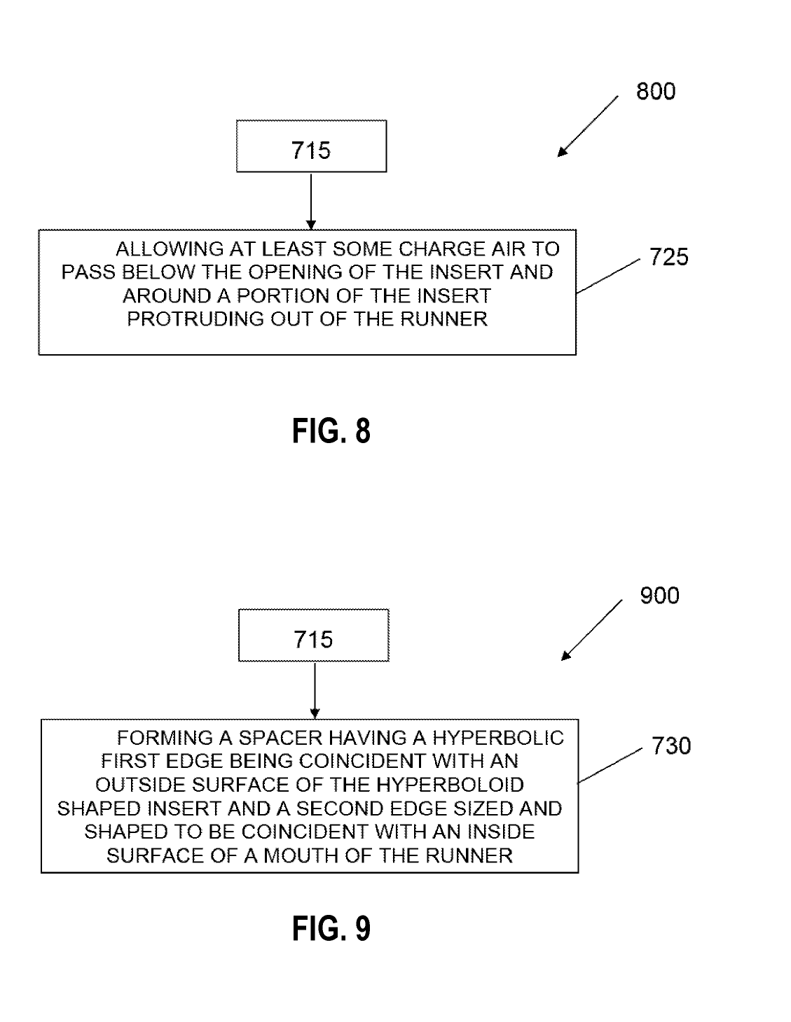

FIG. 6 shows a single turning vane 100 held in position within the manifold by spacers 128. One, or each, of the spacers may have a hyperbolic first edge 130 to mate with a hyperbolic outside surface of the passages and a second 132 edge formed to couple with a mouth of each respective runner 120. Similar spacers with differently shaped edges may be used, and/or included. In addition, or alternatively, other embodiments may include, or may use, different mechanisms to support, and/or hold, the turning vanes 100 within the intake manifold 49. The turning vanes 100 may be held in position within the manifold 49 by spacers 128 such that at least some charge air can enter the respective runner 120 without passing through the respective passage 110.

Embodiments may include a manifold insert 101 that may include, or be a turning vane 100 similar to as described. The manifold insert 101 may include a substantially hyperboloid shaped body 150. The body 150 may define a passage 110 there-through from a relatively wide inlet end 102 to a relatively narrow outlet end 114. The outlet end 114 may be configured to be inserted into a manifold runner 120. The outlet end 114 may be configured to be held in a plenum 104 at a nonzero distance from a mouth of the runner 108. The passage 120 may be configured to direct air into the runner 120 along a predetermined path.

The manifold insert 101 may have an outside surface to couple with a spacer 128. The spacer 128 may be sized and shaped to couple with the mouth of the runner 120. The spacer 128 may allow for at least some charge air to pass along an outside of the insert 101 and directly into the runner 120. The manifold insert 101 may have an outside surface being increasing less obstructive to air moving across the plenum 104 as measured in a direction away from the inlet end 102 and toward the mouth of the runner 108. The manifold insert 101 may be part of a set of similarly configured inserts 101 to be placed in a respective row of runners 120 such that air moving through the plenum 104 in a direction parallel with the row of runners 120 may be increasingly less obstructed closer to the mouth of the runners 108 than relatively closer to the respective inlet ends 102.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Instructions for carrying out one or methods (such as those of FIGS. 7-9) in accordance with the present disclosure may, in some cases be executed by the controller 44 based on instructions stored on a memory of the controller 44 and in conjunction with signals received from sensors of the engine system 10, such as the sensors described above with reference to FIG. 1. In some cases instructions for carrying out one or methods in accordance with the present disclosure may be informed by operations and/or actions fully, or partially controlled by the controller 44 and one or more engine actuators and one or more sensors of the engine system 10.

FIG. 7 is a flow diagram illustrating an example method 700 of modifying a charge air path through an intake manifold in accordance with the present disclosure. The method 700 may include, at 710, placing a hyperboloid shaped insert into the intake manifold by positioning a relatively narrow outlet end of the insert down and into a runner of the intake manifold while allowing a relatively wide inlet end of the insert to protrude into a plenum of the intake manifold. The method 700 may also include, at 715, directing charge air from the inlet end of the insert to the outlet end along a passage having a continually decreasing cross-section in a direction ultimately coincident with a preselected path in the runner.

With some examples, the allowing the relatively wide inlet end of the insert to protrude into the plenum may include disposing the inlet ends of two or more similarly configured inserts in a substantially coplanar arrangement. The inlet ends may all be substantially coequally spaced from corresponding runner mouths. Intermediate portions of each of the inserts may be defined between respective inlet ends and outlet ends each have a width less that the width of the inlet ends. In some cases, the method 700 may include aligning the intermediate portions of the inserts such that charge air passing through the plenum below the level of the inlet ends is relatively less obstructed when relatively closer to the runner mouths.

FIG. 8 is a flow diagram illustrating an example modification of the method 700 of modifying a charge air path through an intake manifold shown in FIG. 7. The modified method 800 may include, at 725, allowing at least some charge air to pass below the opening of the insert and around a portion of the insert protruding out of the runner. In some cases the modified method 800 may also include allowing at least some charge air to pass along an outside of the insert and directly into the runner. In some cases the modified method 800 may also include interposing a spacer between the insert and a mouth of the runner and allowing some charge air to pass into the runner between an outside surface of the insert and the runner walls.

FIG. 9 is a flow diagram illustrating another example modification of the method 700 of modifying a charge air path through an intake manifold shown in FIG. 7. The other example modified method 900 may include, at 730, forming a spacer having a hyperbolic first edge being coincident with an outside surface of the hyperboloid shaped insert and a second edge sized and shaped to be coincident with an inside surface of a mouth of the runner. In some cases the modified method 900 may also include selecting the preselected path in the runner from an experimentally determined ideal airflow path into the runner.

One example of turning vanes for an intake manifold comprises inlet ends to be positioned in a plenum of the intake manifold and disposed substantially coplanar in a plane, the plane at a spaced apart location from respective runner openings; and passages defined by respective one or more surfaces that converge from the inlet ends toward respective outlet ends the passages having a central axis substantially orthogonal with the plane, the one or more surfaces being increasingly less obstructive to air moving across the plenum as measured in a direction away from the inlet end and toward the respective runner openings, the outlet ends positioned within each respective runner opening. In the preceding example, additionally or optionally, the one or more surfaces of each passage forms a cone. In any or all of the preceding examples, additionally or optionally, the one or more surfaces of each passage forms a hyperboloid. In any or all of the preceding examples, additionally or optionally, the one or more surfaces of each passage are arranged substantially in a line extending from to an entry of the plenum to a distance from the entry of the plenum. In any or all of the preceding examples, additionally or optionally, each of the turning vanes is held in position within the manifold by spacers. In any or all of the preceding examples, additionally or optionally, each of the spacers have a hyperbolic first edge to mate with a hyperbolic outside surface of the passages and a second edge formed to couple with a mouth of each respective runner. In any or all of the preceding examples, additionally or optionally, one or more of the turning vanes are sized and positioned within the respective runners to allow at least some charge air to enter the respective runner without passing through the respective turning vanes. In any or all of the preceding examples, additionally or optionally, each of the turning vanes is held in position within the manifold by spacers such that at least some charge can enter the respective runner without passing through the respective passage.

Another example manifold insert comprises a substantially hyperboloid shaped body; and the body defining a passage therethrough from a relatively wide inlet end to a relatively narrow outlet end, the outlet end configured to be inserted into a manifold runner and the outlet end configured to be held in a plenum at a non-zero distance from a mouth of the runner, the passage configured to direct air into the runner along a predetermined path. In the preceding example, the manifold insert additionally or optionally has an outside surface to couple with a spacer, the spacer sized and shaped to couple with the mouth of the runner. In any or all of the preceding examples, additionally or optionally, the spacer allows for at least some charge air to pass along an outside of the insert and directly into the runner. In any or all of the preceding examples, additionally or optionally, the manifold insert has an outside surface being increasing less obstructive to air moving across the plenum as measured in a direction away from the inlet end and toward the mouth of the runner. In any or all of the preceding examples, additionally or optionally, the manifold insert is part of a set of similarly configured inserts to be placed in a respective row of runners such that air moving through the plenum in a direction parallel with the row of runners is increasingly less obstructed closer to the mouth of the runners than relatively closer to the respective inlet ends.

An example method of modifying a charge air path through an intake manifold comprises placing a hyperboloid shaped insert into the intake manifold by positioning a relatively narrow outlet end of the insert down and into a runner of the intake manifold while allowing a relatively wide inlet end of the insert to protrude into a plenum of the intake manifold; and directing charge air from the inlet end of the insert to the outlet end along a passage having a continually decreasing cross-section in a direction ultimately coincident with a preselected path in the runner. In the preceding example, additionally or optionally, the allowing the relatively wide inlet end of the insert to protrude into the plenum includes disposing the inlet ends of two or more similarly configured inserts in a substantially coplanar arrangement the inlet ends all substantially coequally spaced from corresponding runner mouths; and wherein intermediate portions of each of the inserts are defined between respective inlet ends and outlet ends each have a width less that the width of the inlet ends, the method including: aligning the intermediate portions of the inserts such that charge air passing through the plenum below the level of the inlet ends is relatively less obstructed when relatively closer to the runner mouths. In any or all of the preceding examples, additionally or optionally, the method further comprises allowing at least some charge air to pass below the opening of the insert and around a portion of the insert protruding out of the runner. In any or all of the preceding examples, additionally or optionally, the method further comprises allowing at least some charge air to pass along an outside of the insert and directly into the runner. In any or all of the preceding examples, additionally or optionally, the method further comprises interposing a spacer between the insert and a mouth of the runner and allowing some charge air to pass into the runner between an outside surface of the insert and the runner walls. In any or all of the preceding examples, additionally or optionally, the method further comprises forming a spacer having a hyperbolic first edge being coincident with an outside surface of the hyperboloid shaped insert and a second edge sized and shaped to be coincident with an inside surface of a mouth of the runner. In any or all of the preceding examples, additionally or optionally, the method further comprises selecting the preselected path in the runner from an experimentally determined ideal airflow path into the runner.

In a further representation, a manifold insert comprises: a hyperboloid shaped body, the body defining a passage passing through a length of the body from an inlet to an outlet, the inlet of the body wider than the outlet, the insert coupled to a plenum via a spacer on an outer surface of the body so as to juxtapose the outlet at a non-zero distance from a mouth of a runner, the spacer sized and shaped to couple with the mouth of the runner, the passage configured to direct air into the runner along a predetermined path.

In a further representation, a turning vane comprising: a conical shaped insert having a wider inlet, a narrower outlet, a hollow passage defined by a hyperbolically curved surface converging from the inlet to the outlet, one or more triangular spacers coupled to an outer side of the curved surface at the inlet, wherein the spacers provide a defined spacing between the inlet and a mouth of an engine intake plenum runner when the vane is inserted into the runner, and wherein when inserted into the runner, an axis of the passage is orthogonal to an axis of the runner and a plane of the inlet is coplanar to a plane of the mouth of the runner.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. Turning vanes for an intake manifold comprising:
inlet ends to be positioned in a plenum of the intake manifold and disposed substantially coplanar in a plane, the plane at a spaced apart location from respective runner openings; and
passages defined by respective one or more surfaces that converge from the inlet ends toward respective outlet ends the passages having a central axis substantially orthogonal with the plane, the one or more surfaces being increasingly less obstructive to air moving across the plenum as measured in a direction away from the inlet end and toward the respective runner openings, the outlet ends positioned within each respective runner opening.

2. The turning vanes of claim 1, wherein the one or more surfaces of each passage forms a cone.

3. The turning vanes of claim 1, wherein the one or more surfaces of each passage forms a hyperboloid.

4. The turning vanes of claim 1, wherein the one or more surfaces of each passage are arranged substantially in a line extending from to an entry of the plenum to a distance from the entry of the plenum.

5. The turning vanes of claim 1, wherein each of the turning vanes is held in position within the manifold by spacers.

6. The turning vanes of claim 5, wherein each of the spacers have a hyperbolic first edge to mate with a hyperbolic outside surface of the passages and a second edge formed to couple with a mouth of each respective runner.

7. The turning vanes of claim 1, wherein one or more of the turning vanes are sized and positioned within the respective runners to allow at least some charge air to enter the respective runner without passing through the respective turning vanes.

8. The Turning vanes of claim 1, wherein each of the turning vanes is held in position within the manifold by spacers such that at least some charge can enter the respective runner without passing through the respective passage.

9. A manifold insert comprising:
a substantially hyperboloid shaped body; and
the body defining a passage therethrough from a relatively wide inlet end to a relatively narrow outlet end, the outlet end configured to be inserted into a manifold runner and the outlet end configured to be held in a plenum at a non zero distance from a mouth of the runner, the passage configured to direct air into the runner along a predetermined path.

10. The manifold insert of claim 9, having an outside surface to couple with a spacer, the spacer sized and shaped to couple with the mouth of the runner.

11. The manifold insert of claim 10, wherein the spacer allows for at least some charge air to pass along an outside of the insert and directly into the runner.

12. The manifold insert of claim 9, having an outside surface being increasing less obstructive to air moving across the plenum as measured in a direction away from the inlet end and toward the mouth of the runner.

13. The manifold insert of claim 9, being part of a set of similarly configured inserts to be placed in a respective row of runners such that air moving through the plenum in a direction parallel with the row of runners is increasingly less obstructed closer to the mouth of the runners than relatively closer to the respective inlet ends.

14. A method of modifying a charge air path through an intake manifold comprising:
placing a hyperboloid shaped insert into the intake manifold by positioning a relatively narrow outlet end of the insert down and into a runner of the intake manifold while allowing a relatively wide inlet end of the insert to protrude into a plenum of the intake manifold; and
directing charge air from the inlet end of the insert to the outlet end along a passage having a continually decreasing cross-section in a direction ultimately coincident with a preselected path in the runner.

15. The method of claim 14, wherein the allowing the relatively wide inlet end of the insert to protrude into the plenum includes disposing the inlet ends of two or more similarly configured inserts in a substantially coplanar arrangement the inlet ends all substantially coequally spaced from corresponding runner mouths; and
wherein intermediate portions of each of the inserts are defined between respective inlet ends and outlet ends each have a width less that the width of the inlet ends, the method including: aligning the intermediate portions of the inserts such that charge air passing through the plenum below the level of the inlet ends is relatively less obstructed when relatively closer to the runner mouths.

16. The method of claim 14, further comprising:
allowing at least some charge air to pass below the opening of the insert and around a portion of the insert protruding out of the runner.

17. The method of claim 14, further comprising:
allowing at least some charge air to pass along an outside of the insert and directly into the runner.

18. The method of claim 14, further comprising interposing a spacer between the insert and a mouth of the runner and allowing some charge air to pass into the runner between an outside surface of the insert and the runner walls.

19. The method of claim 14, further comprising forming a spacer having a hyperbolic first edge being coincident with an outside surface of the hyperboloid shaped insert and a second edge sized and shaped to be coincident with an inside surface of a mouth of the runner.

20. The method of claim 14, further comprising selecting the preselected path in the runner from an experimentally determined ideal airflow path into the runner.
